(19) United States
(12) Patent Application Publication
(10) Pub. No.: US 2002/0104073 A1
(43) Pub. Date: Aug. 1, 2002

(54) COMPONENT ORIENTED PROGRAMMING (COP) LANGUAGE

(76) Inventors: SANJIVA WEERAWARANA, YORKTOWN HEIGHTS, NY (US); DAVID A. EPSTEIN, OSSINING, NY (US); MATTHEW J. DUFTLER, TARRYTOWN, NY (US); FRANCISCO P. CURBERA, BRONX, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 09/207,046

(22) Filed: Dec. 8, 1998

(51) Int. Cl. G06F 9/44

(52) U.S. Cl. 717/114; 717/107

(57) ABSTRACT

A new Component oriented programming (COP) language enables the explicit definition of the multi-component structure of a system. The syntax of the language is based on a structured markup language, such as XML (eXtensible Markup Lanugage). The language elements are designed to support the important intra- and inter-component relationships of creating and locating components, setting components' properties, associating events between components and arbitrarily configuring components via method calls. These operations form an orthogonal basis for the space of multi-component structures. The COP language abstracts the concept of a component so that there is no difference in specifying any type of component, whether visual or non-visual.

### BACKGROUND OF THE INVENTION

1. Field of the Invention

The present invention generally relates to computer aided software engineering (CASE) and, more particularly, to a new language that enables explicit definition of multi-component structures in object-oriented, componentized design for the building of large-scale systems.

2. Background Description

Object oriented programming (OOP) is the preferred environment for building user-friendly, intelligent computer software. Key elements of OOP are data encapsulation, inheritance and polymorphism. These elements may be used to generate a graphical user interface (GUI), typically characterized by a windowing environment having icons, mouse cursors and menus. While these three key elements are common to OOP languages, most OOP languages implement the three key elements differently.

Examples of OOP languages are Smalltalk, Object Pascal and C++. Smalltalk is actually more than a language; it might more accurately be characterized as a programming environment. Smalltalk was developed in the Learning Research Group at Xerox's Palo Alto Research Center (PARC) in the early 1970s. In Smalltalk, a message is sent to an object to evaluate the object itself. Messages perform a task similar to that of function calls in conventional programming languages. The programmer does not need to be concerned with the type of data; rather, the programmer need only be concerned with creating the right order of a message and using the right message. Object Pascal is the language used for Apple's Macintosh® computers. Apple developed Object Pascal with the collaboration of Niklaus Wirth, the designer of Pascal. C++ was developed by Bjarne Stroustrup at the AT & T Bell Laboratories in 1983 as an extension of C. The key concept of C++ is class, which is a user-defined type. Classes provide object oriented programming features. C++ modules are compatible with C modules and can be linked freely so that existing C libraries may be used with C++ programs. The most widely used object based and object oriented programming languages trace their heritage to Simula developed in the 1960s by O-J. Dahl, B. Myhrhaug and K. Nygard of Norway. Further information on the subject of OOP may be had by reference to Object Oriented Design with Applications by Grady Booch, The Benjimin/Cummings Publishing Co., Inc., Redwood City, Calif. (1991).

Rapid Application Design (RAD) tools, such as Microsoft's Visual Basic, offer a way to produce a software application in a relatively short period of time. Typically, RAD tools are used to generate the “look and feel” of an application, but the code generated by these tools are generally slow in execution. Therefore, many software houses prototype the Graphic User Interface (GUI) of their applications in a RAD tool and then implement the application in C++.

Despite the benefits of object-oriented program development, implementing large applications in, for example, C++ can be expensive. One approach to reducing the cost is to reuse object implementations. Object Oriented Programming (OOP) languages provide some degree of reuse. OOP is about describing how objects interact with one another. Component oriented programming (COP) is designed to produce reusable units of software. COP use building blocks for constructing custom software. Unlike OOP objects, COP hides details above the object-interaction level. There is no inheritance between components, although the objects that make up the component may inherit behavior from other objects, possibly in other components. In other words, when using a component, the inner workings of that component are oblivious to the application using the component. The component always appears as a single interface which formalizes properties, events and behavior. As a result of its well defined interface, a component may be easily reused. Components are to software what integrated circuits (ICs) are to electronics; they encapsulate function and provide services based on a strict specification of their interface. For example, a spell-check component encapsulates the minimum knowledge to completely perform its task. Thus, by combining components, large software applications can be built.

An advantage of COP is an additional level of modularity on top of what OOP already offers. Instead of thinking about how any one given object interacts with another object, the focus is on how entire sets of functionalities interact. OOP does not encapsulate groups of classes and objects. COP hides the information at the class level. Component oriented programming is now well recognized as the most effective approach to dealing with software complexity. Several component models exist in practice today, with Sun Microsystems' JavaBeans component architecture (see JavaBeans spec: http://java.sun.com/beans/docs/spec.html and Developing JavaBeans by Robert Englander et al., O'Rfeilley and Associates, Boston, Mass. (1997)) for the cross-platform Java programming language and Microsoft Corporations's ActiveX component architecture (see Designing and Using ActiveX Controls by Tom Armstrong, M & T Books, Henry Holt & Co., Inc., New York (1997)) being most well known. A recent entry to the component model space is the HTML (hypertext markup language) Component Model, as submitted to the World Wide Web (WWW) Consortium by Microsoft Corporation (see http://www.w3.org/TR/1998/NOTE-HTMLComponents-19981023).

Visual programming enables a programmer to create programs from existing software components from a component library. One such visual programming tool is International Business Machines (IBM) Corporation's VisualAge for Java. To build a program, the programmer uses a Visual Composition Editor that draws a Graphical User Interface (GUI) on the computer screen using a library of tool bars, icons, pull down, pop up and fly out menus, tabs, scroll bars and the like. The picture specifies the components that implements functions of the larger program being built. For user interface controls, the position of the controls relative to each other in the picture specifies how the controls will appear in the final program. For nonvisual components, such as database components, the position of the components in the picture generally has no significance since the components are not displayed at run time. The Visual Composition Editor provides a wiring capability to specify how components of the picture will interact to implement functions of the program. Using connections, the programmer can graphically specify much of the behavior of an application and integrate custom code.

Today, object-oriented, componentized design is currently recognized as the best approach to building large-scale systems. While object-oriented languages well support the implementation of components in an object-oriented system, there currently do not exist languages for describing the higher-level, multi-component structure of a componentized system. Hence, such relationships are implemented using the same language used to implement the components. Even visual application builders, which provide good tools for component oriented programming, are forced to either use the language of the components to describe the multi-component structure of applications or encode them in some proprietary, binary form that is unavailable to the programmer except within the tool.

The problem with such an approach is that representing the multi-component structure in a standard OOP language such as Java or C++ results in a loss of information as to the semantics of the multi-component structure. This occurs because these languages do not have explicit constructs to define such relationships. Consequently, the explicit information about these relationships is either specified in various ad-hoc portions of the code or comments about the code or simply lost.

### SUMMARY OF THE INVENTION

It is therefore an object of the present invention to provide a method to describe a multicomponent structure of a componentized system.

It is also an object to provide a method to support inter-component relationships.

The invention is a new Component Oriented Programming (COP) language that enables the explicit definition of the multi-component structure of a system. Further, the language is directly executable without further compilation. The syntax of the language is based on a structured markup language (see Understanding SGML and XML Tools: Practical Programs for Handling Structured Text by Peter Flynn, Kluwer Academic Publishers (1998)), such as XML (extensible Markup Lanugage). See also XML spec: Http:///www.w3.org/TR/1998/REC-xml-19980210 and Designing XML Internet Applications by Michael Leventhal et al., Prentice Hall PTR, Upper Saddle River, N.J. (1998). Using a structured markup language, allows a clean definition of the component wiring concepts and has the added advantage of not introducing a new syntax for it. However, the concepts of the invention can clearly be expressed in any syntactic model. The language elements are designed to support the important inter-component relationships of creating and locating components, configuring components' properties, associating events between components and arbitrarily configuring components via method calls. These operations form an orthogonal basis for the space of multi-component structures.

The invention abstracts the concept of a component so that there is no difference in specifying any type of component, whether visual or non-visual. The component wiring concepts used by the invention are independent of a specific component model. Concrete realizations of this approach will, however, assume a specific component model, such as the JavaBeans or ActiveX models.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow chart illustrating the semantics of the <bean> element;

FIG. 2 is a flow chart expanding the “configure” function block of the flow chart of FIG. 1;

FIG. 3 is a flow chart illustrating the semantics of the <property> element of the flow chart of FIG. 2;

FIG. 4 is a flow chart illustrating the semantics of the <field> element of the flow chart of FIG. 2;

FIG. 5 is a flow chart illustrating the semantics of the <event-binding> element of the flow chart of FIG. 2;

FIG. 6 is a flow chart illustrating the semantics of the <call-method> element of the flow chart of FIG. 2;

FIG. 7 is a flow chart illustrating the semantics of the <string> element of the flow chart of FIG. 2;

FIG. 8 is a flow chart illustrating the semantics of the <cast> element of the flow chart of FIG. 2;

FIG. 9 is a flow chart expanding on the “get content” function block in the flow charts of FIGS. 3, 4, 6 and 8; and

FIG. 10 is a block diagram showing an example of wiring a set of beans resulting from execution of BML script.

### DETAILED DESCRIPTION OF A PREFERRED EMBODIMENT OF THE INVENTION

The preferred embodiment of the invention is based on a structured markup language, such as XML. In this implementation, the invention consists of several XML elements, including

an element for creating or looking up components,

an element for manipulating a component's properties,

an element for manipulating a component's fields,

an element for interconnecting components via events, and

an element for configuring a component via method calls.

A concrete instance of the invention has been realized for the JavaBeans component model and is called Bean Markup Language (BML). In the JavaBeans component model, a running object, i.e., an instance of a class, is called a “bean”. The model also supports the notions of “serialization”; the process of saving the state of a bean into secondary storage, as well as the process of “de-serialization”; and the process of resurrecting a previously stored bean into its running state. See The Java Programming Language, 2^{nd} Ed., by Ken Arnold and James Gosling, Addison Wesley, Reading, Mass. (1997). The <bean> element is used to create new beans or to look up beans by name. Creating a bean may result in a bean being resurrected from a serialized file or in a new instance of the bean's class being created. After creation, the bean may optionally be registered in to BML's object registry which provides a name to object reference mapping.

The <bean> element also allows one to look up beans previously registered in the object registry. A special feature in the bean element allows one to look up the java.lang. Class object representing some Java class by using the special name [symbol] class:className [symbol] where class Name is the name of the class whose Class object is desired. One possible use of this special feature is to invoke static methods of some class.

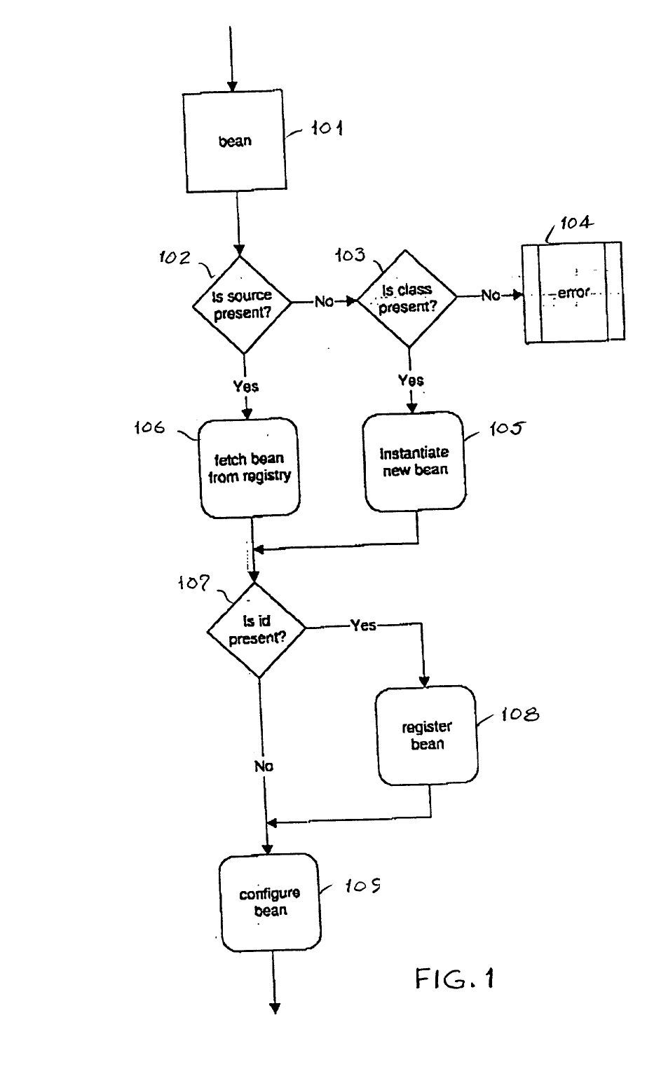

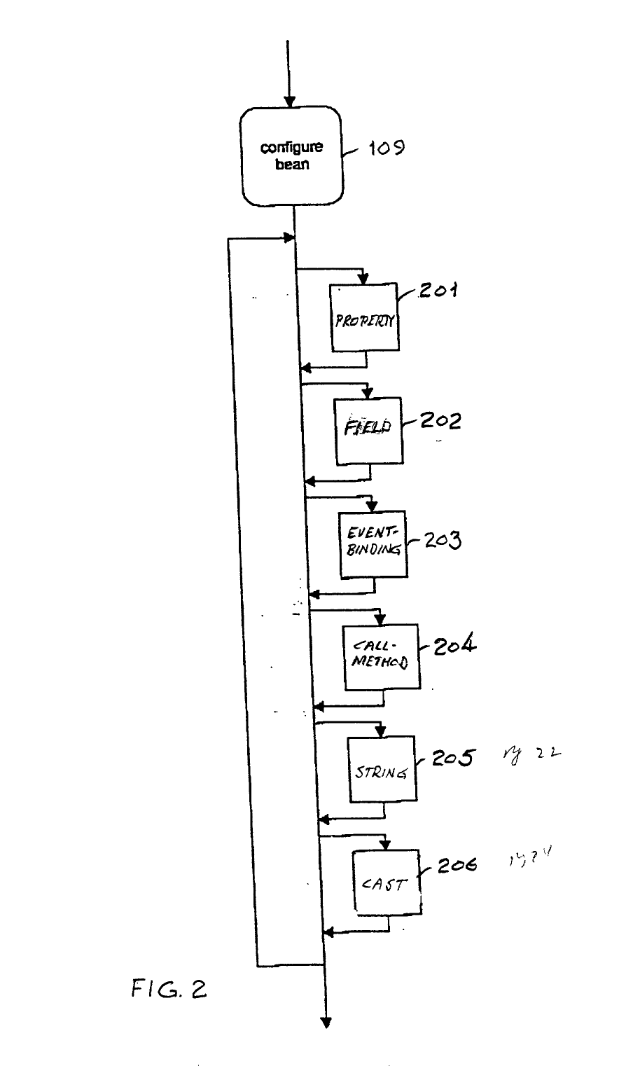

The process is illustrated in FIGS. 1 and 2. Referring first to FIG. 1, a bean is called in function block 101. A test is made in decision block 102 to determine if a source is present. If not, a further test is made in decision block 103 to determine if a class is present. If not, an error is returned in output block 104. If, however, a class is present, then a new bean is instantiated in function block 105. If there was a source present, as determined in decision block 102, then the bean is fetched from the registry in function block 106.

When either a new bean is instantiated in function block 105 or a bean is fetched from the registry in function block 106, a test is made in decision block 107 to determine if an ID (identification) is present. If so, the bean is registered in function block 108. If no ID is present or after the bean has been registered, the bean is configured in function block 109.

Thus, the <bean> element represents the creation of a new bean, or the retrieval of an existing bean from an object registry. When creating a bean, it can be created anew or a previously configured bean can be resurrected from secondary storage. Optionally, beans may be registered for later retrieval.

The sequence of the configuration process is shown in FIG. 2. The content of a bean element is used to configure the bean. Each child element represents one configuration operation, and there may be zero or more child elements. Operations are performed in textual order. These include, in the order illustrated in FIG. 2, the <property> element 201 of the bean, the <field> element 202 of the bean, the <event-binding> element 203 of the bean, the <call-method> element 204 of the bean, the <string> element 205 of the bean, and the <cast> element 206 of the bean.

Once the bean has been created or looked up, the children of the bean element are processed with the context bean set to this bean. That is, if a <call-method> element were present as a child, for example, unless otherwise state in the <call-method> element, the call would occur on the bean identified by the containing <bean> element. If there are no children elements, then processing the <bean> element simply results in that bean.

Given below are the various usages of the <bean> element, with the syntax, semantics and examples for each.

Case 1:

Creating a bean by instantiating a class using its no-args constructor or by resurrection and optionally registering it:

Syntax:

<bean class = “class-name-or-.ser-file-name”

[id = “name-to-register-as-”]>

... configure bean ...

</bean>

Semantics:

A new instance is created by either locating a serialized file with the given name or by creating a new instance from the class using its no-args constructor. If the “id” argument is present, the bean is registered into the object registry with that name as the key.

Example:

<bean class = “java.awt.Panel” id = “topPanel”

... configure bean ...

</bean>

Case 2:

Creating a bean by instantiating a class with a specific constructor and optionally registering it:

Syntax:

<bean class = “class-name” [id = “name-to-register-as”]>

<args>

constructor-arg-1
constructor-arg-2

. . .

constructor-arg-n

</args>

... configure bean ...

</bean>

Semantics:

After loading the class, a constructor whose signature matches the types of the arguments (using the algorithm defined by the Java language specification) is located and used to instantiate the bean. If the “id” argument is present, the bean is registered into the object registry with that name as the key.

Example:

<bean class = “java.awt.Dimension”>

<args>

<cast class = “int”> <string>200</string> </cast>
<cast class = “int”> <string>100</string> </cast>

</args>

</bean>

Case 3:

Looking up a previously registered bean:

Syntax:

<bean[class = “class-of-registered-bean”] source = “previously-

registered-name”>

... configure bean ...

</bean>

Semantics:

The name is looked up in the object registry. The “class” attribute is optional, but required if this BML script is being compiled and if the bean itself is registered only at run-time. In this case, without this information, the BML compiler would have no information about the bean in order to compile the script. Once the bean is found, the associated object is returned.

Examples:

<bean source = “topPane”>

... configure bean ...

</bean>
<bean source = “myBean” class = “class-of-myBean”>

... configure bean ...

</bean>

Case 4:

Looking up a class bean:

Syntax:

<bean source = “class:name-of-class-to-find”>

... configure bean ...

</bean>

Semantics:

The class name “name-of-class-to-find” is loaded and the instance of java.lang.Class object representing it is returned. Special recognition has been given to the names “boolean”, “byte”, “char”, “short”, “int”, “lont”, “float”, and “double” to enable access to the class objects representing the primitive types. For example, setting the source attribute to “class:int” would retrieve the object java.lang.Integer.TYPE. This can be used to make static method calls, for example.

Examples:

<bean source = “class:java.lang.System”>

<call-method name = “currentTimeMillis”/>

</bean>
<bean class = “java.awt.Button”>

<event-binding name = “action” target = “myActionHandler”

targetMethod = “dolt”>

<bean source = “class:java.awt.event.ActionEvent”/>

</event-binding>

</bean>

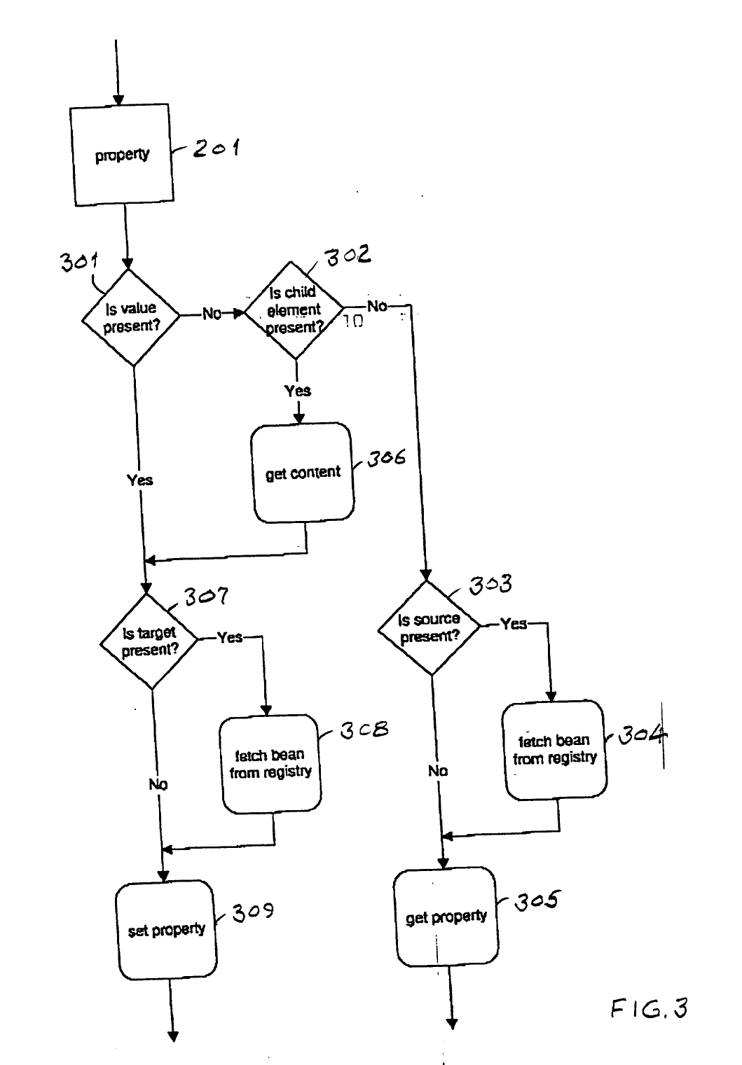

FIG. 3 illustrates the semantics of the <property> element 201 in FIG. 2. A test is made in decision block 301 to determine if a value is present. If not, a further test is made in decision block 302 to determine if a child element is present. If not, yet another test is made in decision block 303 to determine if a source is present. If so, the bean is fetched from the registry in function block 304. If not, or after the bean is fetched from the registry, the property is retrieved in function block 305.

Returning to decision block 302, if a child element is present, then the content is retrieved in function block 306. If a value is present as determined in decision block 301, or after the content is retrieved in function block 306, a test is made in decision block 307 to determine if a target is present. If so, the bean is fetched from the registry in function block 308. If not, or after the bean is fetched from the registry, the property is set in function block 309.

The <property> element allows one to get the value of a property or to set the value of a property to some value. The value may be immediate or the return value of some other appropriate BML element. The property setting or getting is performed on the default target bean (i.e., the bean identified by the <bean> element in which this element is contained), unless otherwise specified in this element. The different cases if using the <property> element are listed below. Case 1:

Setting a property value with an immediate value:

Syntax:

<property [target = “alternate-bean”] name = “property-name”

value = “property value”/>

Semantics:

This is a syntactic short-cut for:

<property [target = “alternate-bean”] name = “property-name”>

<string>property-value</string>

</property>

See the case below for its semantics.

Example:

<bean class = “java.awt.Label>

<property name = “text” value = “Hello There!”/>

</bean>

Case 2:

Setting a property value with an indirect value:

Syntax:

<property [target = “alternate-bean”] name = “property-name”>

... a bean, string, field, property, call-method or cast element ...

</property>

Semantics:

Sets the value of the property to the given value. The value is obtained by evaluating the single child element and obtaining the return value (bean). If the target attribute is present, then the operation is performed on the bean with that name instead of the default (i.e., containing) bean by first looking up that name in the object registry and then setting the value of the property. If the type of the value and the type of the property do not match (or are not assignable), a type conversion will be necessary. For example, setting the background color of an AWT component to blue would require a convertor to convert the string “0x0000ff” to the appropriate java.awt.Color object representing that color. BML uses a registry of available type convertors (TypeConvertorRegistry) which provides a reference to a TypeConvertor object that can handle the necessary conversion. The convertor is dynamically invoked with the value to be converted and the result used as the value of the property.

Example:

<bean class = “java.awt.Frame”>

<property name = “layout”>

<bean class = “java.awt.BorderLayout”/>

<property>

</bean>

Case 3:

Getting a property value:

Syntax:

<property [source = “alternate-bean”] name = “property-name”/>

Semantics:

Returns the value of the named property as a bean. If the source attribute is present, then the operation is performed on the bean with that name instead of the default (i.e., containing) bean by first looking up that name in the object registry and then getting the value of the property. A common use of this element is to set a property of one bean to be the value of a property of another bean.

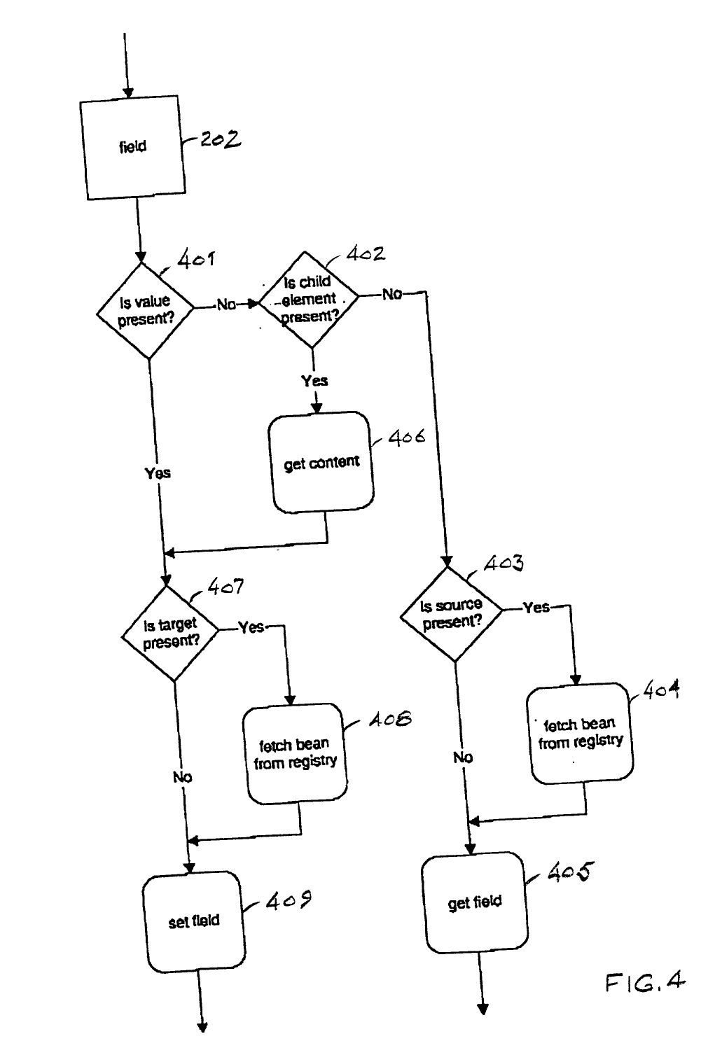

FIG. 4 illustrates the syntax of the <field> element 202 in FIG. 2. A test is made in decision block 401 to determine if a value is present. If not, a further test is made in decision block 402 to determine if a child element is present. If not, yet another test is made in decision block 403 to determine if a source is present. If so, the bean is fetched from the registry in function block 404. If not, or after the bean is fetched from the registry, the property is retrieved in function block 405.

Returning to decision block 402, if a child element is present, then the content is retrieved in function block 406. If a value is present as determined in decision block 401, or after the content is retrieved in function block 406, a test is made in decision block 407 to determine if a target is present. If so, the bean is fetched from the registry in function block 408. If not, or after the bean is fetched from the registry, the property is set in function block 409.

The <field> element allows one to get the value of a field or to set the value of a field to some value. The value may be immediate or the return value of some other appropriate BML element. The field setting or getting is performed on the default target bean (i.e., the bean identified by the <bean> element in which this element is contained), unless otherwise specified in this element. Static fields may be manipulated by setting the target bean to the class object which owns the field. The <field> element semantics are almost exactly the same as those of the <property> element and are included here for the sake of completeness. The primary difference between <field> and <property> is that fields may be static. At a bean level, the access to fields and properties is via completely different techniques, but this is internal to the implementation and not of importance to the BML user. The different cases if using the <field> element are listed below.

Case 1:

Setting a field value with an immediate value:

Syntax:

<field [target = “alternate-bean”] name = “field-name”

value = “field-value”/>

Semantics:

This is a syntactic short cut for:

<field [target = “alternate-bean”] name = “field-name”

<string> field-value</string>

</field>

See the case below for its semantics.

Example:

<bean class = “myClass”>

<field name = “size” value = “100”/>

</bean>

Case 2:

Setting a field value with an indirect value:

Syntax:

<field [target = “alternate-bean”] name = “property-name”>

... a bean, string, field, property, call-method or cast element ...

</field>

Semantics:

Sets the value of the field to the given value. The value is obtained by evaluating the single child element and obtaining the return value (bean). If the target attribute is present, then the operation is performed on the bean with that name instead of the default (i.e., containing) bean by first looking up that name in the object registry and then setting the value of the field. If the type of the value and the type of the field do not match (or are not assignable), a type conversion will be necessary. BML uses a registry of available type convertors (TypeConvertorRegistry) which provides a reference to a TypeConvertor object that can handle the necessary conversion. The convertor is dynamically invoked with the value to be converted and the result used as the value of the field.

Example:

<bean class = “myClass”>

<field name = “size”>

<string>100</string>

</field>

</bean>

Case 3:

Getting a field value:

Syntax:

<field [source = “alternate-bean”] name = “property-name”/>

Semantics:

Returns the value of the named field as a bean. If the source attribute is present, then the operation is performed on the bean with that name instead of the default (i.e., containing) bean by first looking up that name in the object registry and then getting the value of the field.

Example:

<bean class = “java.awt.Label”>

<property name = “alignmentl> <!-- center the label -->

<field source = “class.java.awt.Label” name = “CENTER”/>

</property>

</bean>

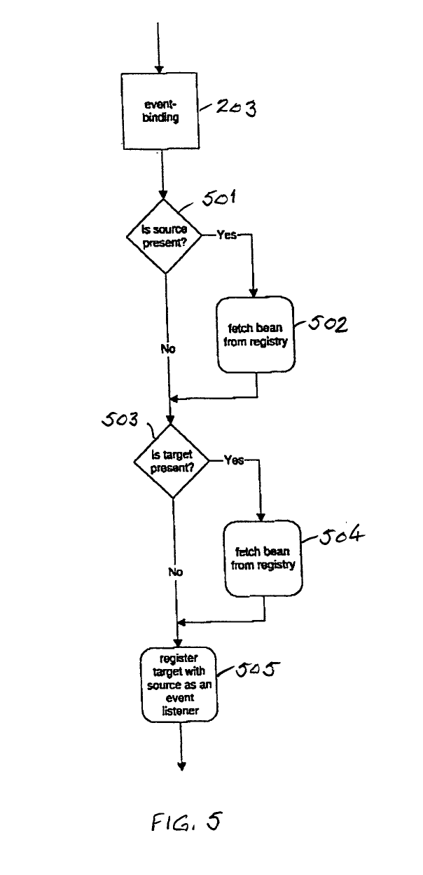

FIG. 5 illustrates the syntax of the <event-binding> element 203 in FIG. 2. A test is made in decision block 501 to determine if a source bean is present. If so, the source bean is fetched from the registry in function block 502. If no source is present or after the source bean is fetched from the registry, a test is made in decision block 503 to determine if a target bean is present. If so, the target bean is fetched from the registry in function block 504. If not or after the target bean has been fetched from the registry, the target bean is attached with the source bean as a listener of the desired event in function block 505.

The <event-binding> element supports binding of events from a bean to something else. The JavaBeans event model states that if a bean (“source”) can generate an event of type XEvent, then any listener (“target”) must implement the XListener interface. Beans that implement the listener interface for an event can be registered as a listener of that event at the source bean. The listener interface defines a set of methods via which the event may be delivered by the event source to the event listener. Details of binding an event from a source to a recipient bean which implements the requisite listener interface are given below:

Syntax:

<event binding [source = “alternate-bean”>

name = “event-set-name” [target = “target-bean”] />

Semantics:

Makes the target bean a listener of “event-set name° events from the source bean. If the source attribute is present, then the operation is performed on the bean with that name instead of the default (i.e., containing) bean by first looking up that name in the object registry and then using that. Similarly for the source attribute. The target bean most implement the necessary listener interface or this operation will fail.

Examples:

<bean class = “java.awt.Button”>

<event-binding name = “action” target = “myActlonHandler”/>

</bean>
<bean class = “java.awt.TextField”>

<event-binding name = “text” target = “myTextHandler”/>
</bean>

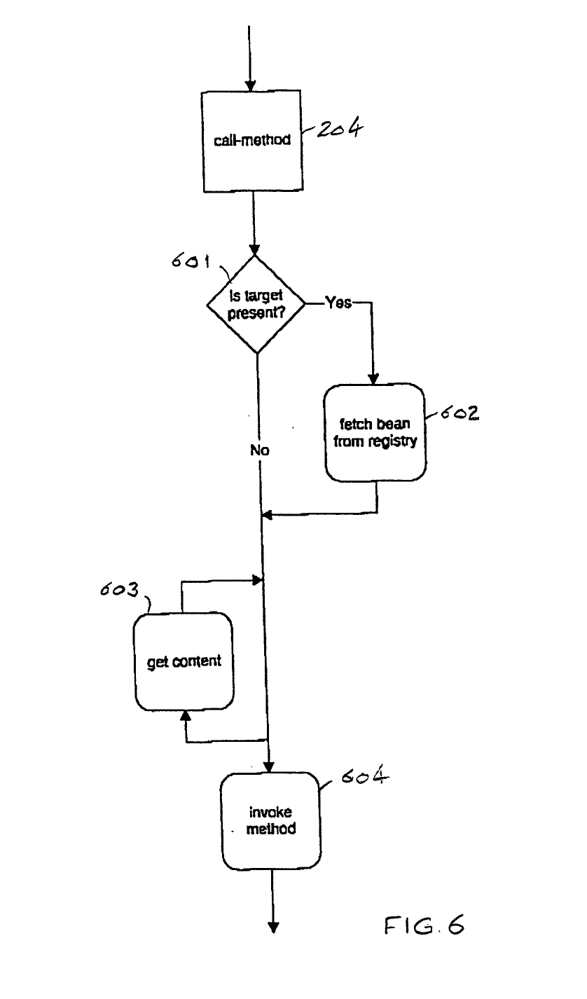

FIG. 6 illustrates the semantics of the <call-method> element 204 in FIG. 2. A test is made in decision block 601 to determine if a target bean is present. If so, the target bean is fetched from the registry in function block 602. If not or after a target bean has been fetched from the registry, the get content function is called in function block 603. Then, in function block 604, the method is invoked.

The <call-method> element can be used to call methods on beans. Calling a method involves identifying the name of the method to call, the bean on which to call that method and the arguments to the method. The actual method to call is determined using the types of the arguments and applying the Java language method resolution algorithm to find the precise method. (The return type is not necessary to identify the method as Java does not allow overloading on return types.)

Syntax:

<call-method [target = “alternate-bean”] name = “method-name”>

... zero or more bean, string, field, property, call-method or cast

elements ...

</call-method>

Semantics:

Calls the named method on the target bean. If the target attribute is present, then the operation is performed on the bean with that name instead of the default (i.e, continuing) bean by first looking up that name in the object registry and then using that. The sequence of arguments to the call is created by evaluating all the child elements In order. The signature of the method to search tor is defined by the types of the arguments. The method Itself is determined using the Java language method resolution logic to find the method with the best matching signature in the target bean's class. The Static methods can be invoked via <call-method> by setting the target object to the class object of the desired class. Return bean of the method call (if any) is the value of this element.

Examples:

<bean class = “java.awt.Frame”>

<call-method name = “pack”/>
<call-method name = “show”/>

</bean>
<bean class = “java.awt.Panel”>

<call-method name = “setBounds”>

<cast class = “int”> <string>100</string> </coast>
<cast class = “int”> <string>100</string> </coast>
<cast class = “int”> <string>20</string> </cast>
<cast class = “int”> <string>50</string> </coast>

</call-method>

</bean>

Once the bean has been created or looked up, the children of the bean element are processed with the context bean set to this bean. That is, if a <call-method> element were present as a child, for example, unless otherwise stated in the <call-method> element, the call would occur on the bean identified by the containing <bean> element. If there are no children elements, then processing the <bean> element simply results in the bean.

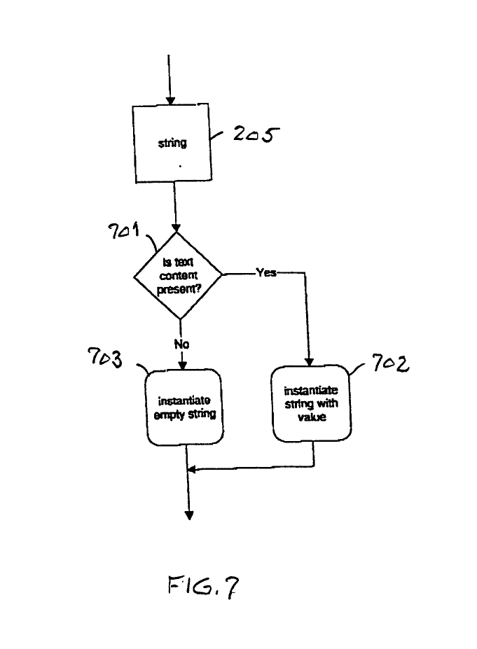

String valued beans have to be treated differently in BML because of the special treatment of strings in both XML and Java. The solution that BML takes is to introduce a new element, the <string> element. This element is used to create string beans. FIG. 7 illustrates the syntax of the <String> element 205 shown in FIG. 2. A test is made in decision block 701 to determine if text content is present. If so, a new string bean with that value is created and returned in function block 702. If not, an empty string is instantiated in function block 703.

These two cases of usage of the <string> element are as follows:

Case 1:

Creating a string with a non empty value:

Syntax:

<string> value-of-strlng</string>

Semantics:

An instance of class java.lang. String is returned with the value “value of-string”. The entire contents between the open and close tags are used as the value (including any white space).

Example:

<bean class = “java.awt.Dimension”>

<args>

<cast class = “int”> <string>200</string> </cast>
<cast class = “int”> <string>100</string> </cast>

</args>

</bean>

Case 2:

Creating an empty string:

Syntax:

<string/>

Semantics: This is entirely equivalent to

<bean class = “java.lang.String”/>.

Example:

<bean source = “class:java.lang.System>

<call-method name = “getProperty”>

<string> userName</string>
<string/>

</call-method>

</bean>

As has been mentioned above, BML's <property> and <field> elements may implicitly invoke a type convertor to convert one type to another. The <cast> element allows one to explicitly convert one type to another. The <cast> may be purely declarative (i.e., simply a relabeling of the bean to be considered to be one of its super types instead of its type) or actual (where a type conversion is performed).

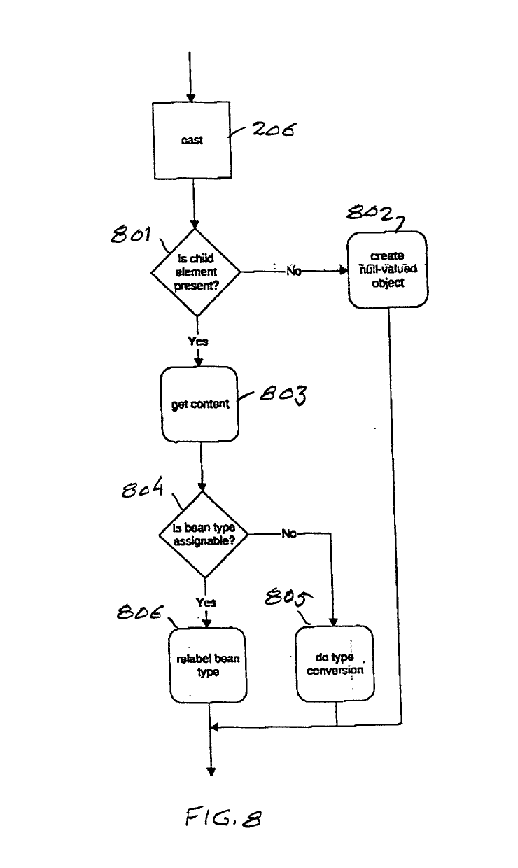

FIG. 8 illustrates the semantics of the <cast> element. A test is made in decision block 801 to determine if a child element is present. If not, a null valued bean of the desired type is created by the function block 802 and returned. If so, the get content function is called in function block 803, and then a test is made in decision block 804 to determine if the type of the child bean is assignable without type conversion to the desired type. If not, an explicit type conversion is done in function block 805 to create a new bean of the desired type. If so, the child bean is re labeled as being of the desired type in function block 806.

Syntax:

<cast class = “class-to-convert-to”>

... a bean, string, field, property, call-method or cast element ...

</cast>

Semantics:

If no content is found, then this is the same as “(class-to-convert-to)null”; i.e., the null value of the appropriate type. If a child element is found, then that element is type converted to the target class (actually or by re-labeling if the value is assignable to the target class). A common use of the <cast> element is to affect the method selection process of <call-method>. BML uses a registry of available type convertors (TypeConvertorRegistry) which provides a reference to a TypeConvertor object that can handle the necessary conversion. The convertor is dynamically invoked with the value to be converted and the result used as the value of the field.

Examples:

<bean source = “class:java.lang.System”>

<call-method name = “getProperty”>

<string>userName</string>
<cast class = “java.lang.String”/>

</call-method>

</bean>
<bean class “java.awt.Panel”>

<call-method name = “setBounds”>

<cast class = “int”><string>100</string></cast>
<cast class = “int”><string>100</string></cast>
<cast class = “int”><string>20</string></cast>

<cast class = “int”><string>50</string></cast>

</call-method>

</bean>

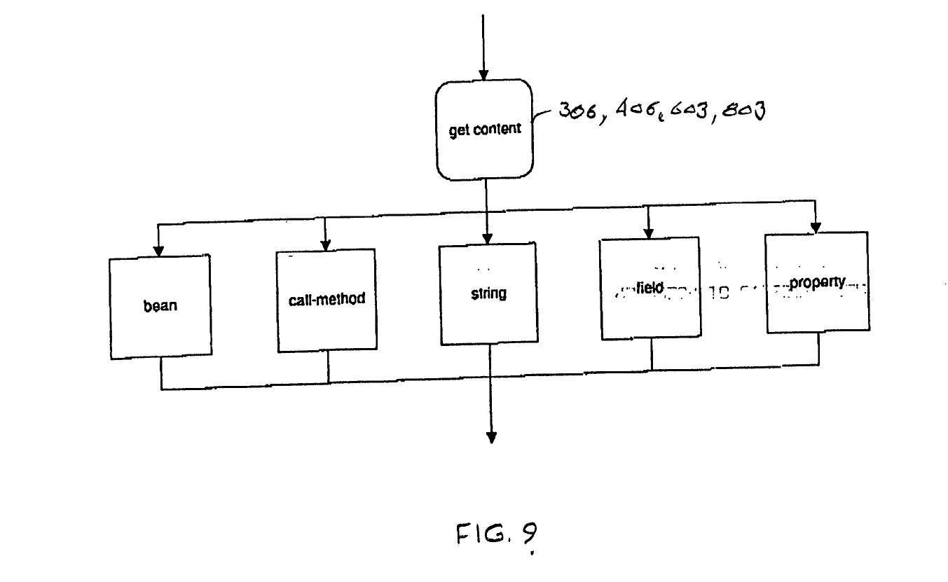

The “get content” function called in the flow charts of FIGS. 3, 4, 6 and 8 is shown in FIG. 9. Most elements refer to the this function to indicate the operation of accessing their children elements. The containing elements (i.e., the children) is defined by each of the elements themselves.

The component configuration model described in this invention can be implemented either in a static (compile-time) form or a dynamic (run-time) form. For the specific instance of BML, we have implemented both a compiler (static) as well as a player (dynamic) to run the configurations.

The processing model employed by a BML processor is as follows. Each element of the BML script is processed in the order it is presented by calling the appropriate processing function based on the name of the element. The <bean> element, in addition to its normal processing tasks described earlier, has the side effect of updating the default bean on which operations are performed. That is, when children elements of the <bean> element are processed, the default bean on which those operations are performed is by default the bean created or looked up by the nearest <bean> element. Of course, as described above, any element may optionally define the bean on which to operate on directly. The operations are done beans using the Java refection technology from Sun Microsystems, Inc. (see Arnold and Gosling, supra). The result of processing any element is the bean that the operation was performed on or that was returned as a result of doing the operation. The result of an entire BML script is the result of the outermost <bean>element.

The following example illustrates the principles of the invention. The example is that of a thermostat in a home to control heating and cooling. The BML script below describes the wiring of a set of beans for the example.

| A | <bean class = “demos.thermo.Thermometer” id = “Thermometer”/> | |
|---|---|---|
| B | <bean class = “demos.thermo.Temperature” id = “Temp”> | |
| | | <property name = “temperature” value = “0”/> |
| | 1 | <event-binding name= “propertyChanges” |

target= “Thermometer”/>

| | |
|---|---|
| | </bean> |
| C | <bean class = “demos.thermo.Thermostat” |

id = “Thermo”>

| | |
|---|---|
| 2 | <event-binding name = “propertyChange” |

source = “Temp”/>

| | |
|---|---|
| 3 | <event-binding name= “unitChange” |

target = “Thermometer”/>

| | |
|---|---|
| 4 | <event-binding name = “unitChange” target = “Temp”/> |
| 5 | <event-binding name= “vetoableChange” |

target= “Temp”/>

| | </bean> | |
|---|---|---|
| D | <bean class = “demos.thermo.Weather” id = “Weather”> | |
| | 6 | <event-binding name= “temperaturePulse” |

target= “Temp”/>

| | </bean> | |
|---|---|---|
| E | <bean class = “demos.thermo.Boiler” id = “Boil”> | |
| | 7 | <event-binding name= “temperaturePulse” |

target= “Temp”/>

| | |
|---|---|
| 8 | <event-binding name= “heatingRequest” |

source = “Thermo”/>

| | </bean> | |
|---|---|---|
| F | <bean class = “demos.thermo.Cooler” id = “Cool”> | |
| | 9 | <event-binding name= “temperaturePulse” |

target = “Temp”/>

| | |
|---|---|
| 10 | <event-binding name= “collingRequest” |

source = “Thermo”/>

</bean>

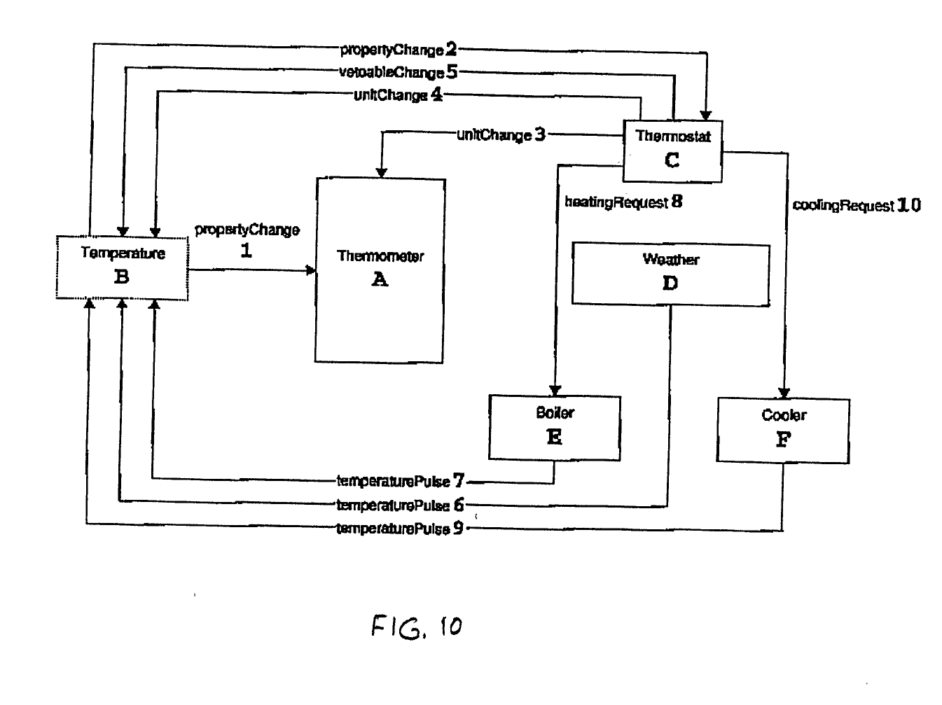

FIG. 10 is a block diagram showing the results from executing the above script. In FIG. 10, the bold-faced alpha-numeric characters of the script are used as reference numerals to correlate the script with the diagram.

While the invention has been described in terms of a single preferred embodiment, those skilled in the art will recognize that the invention can be practiced with modification within the spirit and scope of the appended claims.

Having thus described our invention, what we claim as new and desire to secure by letters patent is as follows:

1. A Component Oriented Programming (COP) language that provides explicit definition of a multi-component structure of a software system so as to enable the separation of the specification of the multi-component software structure from the definition and implementation of the components.

2. A COP language according to claim 1, wherein said COP language is directly executable.

3. A COP language according to claim 2, wherein said COP language is based on a structured markup language.

4. A COP language according to claim 3 that creates new components.

5. A COP language according to claim 4 that creates components using a no-argument constructor.

6. A COP language according to claim 4 that creates components by resurrection from a serial file.

7. A COP language according to claim 6 that registers said created component resurrected from said serial file.

8. A COP language according to claim 4 that creates components using a specific constructor.

9. A COP language according to claim 8 that registers said created component with said specific constructors.

10. A COP language according to claim 3 that creates provides for looking up existing components.

11. A COP language according to claim 10 wherein said existing component is a previously registered component.

12. A COP language according to claim 10 wherein said existing component is a class component.

13. A COP language according to claim 3 that provides for manipulating a component's properties.

14. A COP language according to claim 13 that provides for setting said property with an immediate value.

15. A COP language according to claim 13 that provides for setting said property with an indirect value.

16. A COP language according to claim 13 that provides for getting said property value.

17. A COP language according to claim 3 that provides for manipulating a component's fields.

18. A COP language according to claim 17 that provides for setting a component's field with an immediate value.

19. A COP language according to claim 17 that provides for setting a component's field with an indirect value.

20. A COP language according to claim 17 that provides for getting a component's field value.

21. A COP language according to claim 3 that provides for binding a source component to a recipient component.

22. A COP language according to claim 3 that provides for calling a named method of a component.

23. A COP language that provides for creating a string component with a non-empty value.

24. A COP language that provides for creating a string component with an empty value.

25. A COP language according to claim 3 that provides for casting a component.

26. A COP language that enables explicit definition of a multi-component structure of a software system, the COP language having a syntax based on a structured markup language and being directly executable without further compilation, the COP language configuring a component to include elements selected from the group comprising a property element, a field element, an event-binding element, a call-method element, a string element, and a cast element, the elements supporting inter-component relationships of creating and locating components, configuring components' properties, associating events between components and arbitrarily configuring components via method calls, the COP language capturing in a textual, rigorous way the multi-component structure of a componentized software system enabling the separation of the specification of the multi-component software structure from the definition and implementation of the components themselves.
